(19) United States
(12) Patent Application Publication
(10) Pub. No.: US 2026/0042877 A1
(43) Pub. Date: Feb. 12, 2026

(54) ISOCYANATE-TERMINATED PREPOLYMER FOR COATING APPLICATIONS

(71) Applicant: Covestro Deutschland AG, Leverkusen (DE)

(72) Inventors: Anne Kutz, Korschenbroich (DE); Christos Karafilidis, Leverkusen (DE); Laura Woods, Köln (DE); Monika Leutbecher, Bergisch Gladbach (DE)

(21) Appl. No.: 18/843,751

(22) PCT Filed: Mar. 15, 2023
(86) PCT No.: PCT/EP2023/056628

§ 371 Date: Sep. 4, 2024

(30) Foreign Application Priority Data
Mar. 16, 2022 (EP) 22162433.1

(51) Int. Cl. C08G 18/10; C08G 18/22; C08G 18/32; C08G 18/42; C08G 18/48; C08G 18/78; C09D 175/06; C09J 175/06

(52) U.S. Cl. CPC C08G 18/10; C08G 18/222; C08G 18/3206; C08G 18/4277; C08G 18/4825; C08G 18/7837; C09D 175/06; C09J 175/06; C08G 2150/00; C08G 2170/00

(57) ABSTRACT

The present application relates to an isocyanate-terminated prepolymer obtained by reaction of
(I) At least one polyol, with a stoichiometric excess of
(II) At least one monomeric diisocyanate,
   wherein the isocyanate-terminated prepolymer has
i. a functional group equivalent weight FGEW of ≥560 g/mol,
ii. a content of residual non-reacted monomeric diisocyanate of <0.2% by weight.

The present invention relates to a isocyanate-terminated prepolymer for example for coating applications, to a process for preparing the isocyanate-terminated prepolymer and to the use of the isocyanate-terminated prepolymer. The present invention further relates to a two-component-system, comprising a component A) comprising at least the isocyanate-terminated prepolymer and a component B) comprising at least one compound which comprises at least one Zerewitinoff-active group.

It is known that isocyanate-terminated prepolymers can be used as curing components in polyurethane coating or coating systems. These prepolymers are generally obtained by reacting polyols with di- or polyisocyanates. As a curing component, the prepolymers then react in the coating or coating system with further polyols, for example with polyacrylate polyols, to give the corresponding polyurethanes. The coating system can for example be used in original equipment manufacturer (OEM) coating processes or manual coating application in the refinish sector.

One problem in particular for manual applications, e.g. in the refinish sector, with the isocyanate-terminated prepolymers is that coaters must be careful not to be exposed to the isocyanate-terminated prepolymers because these may cause skin sensitisation, e.g. they may cause an allergic skin reaction. Therefore, expensive handling systems and/or protective measures must be employed during use of the prepolymers to remedy such skin sensitisation problems.

The skin sensitisation potential date of commercial products are available from a safety data sheet (SDS) attached to each product. In particular, SDSs complied with Globally Harmonized System of Classification and Labelling of Chemicals (GHS) are preferred. Some isocyanate-terminated prepolymers may cause an allergic reaction with the skin upon contact with them and accordingly the SDS of the isocyanate-terminated prepolymers has H317 as GHS hazard statement.

The object of the present invention is to provide isocyanate-terminated prepolymers with reduced skin sensitisation potential or even which have no skin sensitisation potential.

Here, an isocyanate-terminated prepolymer which has no skin sensitisation potential refers to a compound that is evaluated as having a lysine mean depletion in the modified Direct Peptide Reactivity Assay (DPRA) test of ≤1.00%.

The Direct Peptide Reactivity Assay (DPRA) is designed to mimic the covalent binding of electrophilic chemicals to nucleophilic centers in skin proteins by quantifying the reactivity of chemicals towards the model synthetic peptides containing either cysteine or lysine. The inventors surprisingly have found a correlation between a negative Local Lymph Node Assay (LLNA) and a lysine depletion in the DPRA test of ≤1.00%, so a lysine depletion in the DPRA test of ≤1.00% reflects non-skin sensitivity. In the present invention the peptide depletion in the DPRA test is performed with lysine as peptide. Lysine % depletion values are used herein to categorize a substance as potential skin sensitiser or non-skin sensitizer.

The object has surprisingly been achieved by providing an isocyanate-terminated prepolymer obtained or obtainable by reaction of
(I) At least one polyol, with a stoichiometric excess of
(II) At least one monomeric diisocyanate,
wherein the isocyanate-terminated prepolymer has
i. a functional group equivalent weight FGEW of ≥560 g/mol,
ii. a content of residual non-reacted monomeric diisocyanate of less than 0.2% by weight, based on the total solid content of the isocyanate-terminated prepolymer.

An advantage of the isocyanate-terminated prepolymers according to the invention is that the working safety of workers using the isocyanate-terminated prepolymers according to the invention is increased. In addition, the safety labelling and associated risk phrases can be less stringent compared to isocyanate-terminated prepolymers not according to the invention, which advantageously results in less stringent safety measures and protection prescriptions for using isocyanate-terminated prepolymers according to the invention. In view of the reduced skin-sensitisation potential of the NCO-terminated prepolymer according to the invention, these prepolymers can advantageously be used in manual applications, such as manual coating applications or in foaming or sealants in the building industry.

The prepolymer containing free isocyanate groups is obtained or obtainable by reacting at least one polyol with at least one monomeric diisocyanate, wherein the at least one monomeric diisocyanate is used in an amount such that the NCO groups are present in molar excess relative to the hydroxyl groups of the at least one polyol to obtain a prepolymer containing free isocyanate groups.

“NCO” as used herein refers to the isocyanate group —N═C═O. “NCO-terminated or isocyanate-terminated” as used herein refers to a prepolymer that contain at least one free NCO-group at one of their ends.

As used herein, the term “functional group equivalent weight FGEW” refers to the number average molecular weight per isocyanate functional group, and is a value obtained by dividing the number average molecular weight (Mₙ) of the isocyanate terminated prepolymer, obtained via Gel permeation Chromatography, by the average number of isocyanate groups per molecule (NCO functionality).

The isocyanate-terminated prepolymer has a functional group equivalent weight FGEW of ≥560 g/mol, preferably ≥600 g/mol, more preferably ≥650 g/mol, more preferably ≥700 g/mol, even more preferably ≥800 g/mol and even more preferably ≥1000 g/mol. This has the advantage that the working safety of workers using the isocyanate-terminated prepolymers according to the invention is further increased. In view of the skin sensitisation potential, there is no preferred upper limit for the FGEW. In view of the applicability in for example the coating, adhesive, foam or sealant application, the isocyanate-terminated prepolymer preferably has a functional group equivalent weight FGEW of ≤10000 g/mol, preferably ≤4000 g/mol, more preferably ≤2000 g/mol.

The isocyanate-terminated prepolymer according to the invention has a content of residual non-reacted monomeric diisocyanate of <0.2% by weight, preferably <0.1% by weight, based on the total solid content of the isocyanate-terminated prepolymer. This has the advantage that the working safety of workers using the isocyanate-terminated prepolymers according to the invention is further increased.

The isocyanate-terminated prepolymer according to the invention preferably has a number-average molecular weight Mₙ of from 1100 to 160000 g/mol, preferably from 1100 to 64000 g/mol, more preferably from 1100 to 32000 g/mol.

According to this invention, if not otherwise specified, the average molecular weight is defined as the number average molecular weight Mₙ. As molecular weight of polymers the number average molecular weight Mₙ is applied. Mₙ is determined via gel permeation chromatography (GPC) at 23° C. in tetrahydrofuran as the solvent. The measurement is performed as described in DIN 55672-1 (the DIN-version used was the version of 03-2016): “Gelpermeationschromatographie, Teil 1—Tetrahydrofuran als Elutionsmittel” (SECurity GPC-System from PSS Polymer Service, flowrate 1.0 ml/min; columns: 2×PSS SDV linear M, 8×300 mm, 5 μm; RID-detector). Samples of polystyrene standards of known molecular weight were used for calibration. The calculation of the number average molecular weight was performed by software. Baseline values and evaluation threshold values were determined according to above referenced DIN 55672 Teil 1.

The isocyanate-terminated prepolymer according to the invention preferably has a content of ≤15% by weight of oligomers having a number average molecular weight≤1000 g/mol, based on the total solid content of the NCO-terminated prepolymer.

The isocyanate-terminated prepolymer contains urethane groups and/or allophanate groups and optionally functional groups selected from the group consisting of urea groups, biuret groups, uretdione groups, carbodiimide groups, uretonimine groups, isocyanurate groups and any combination thereof.

The isocyanate-terminated prepolymer according to the invention is preferably the reaction product of
(I) At least one polyol, and
(II) At least one monomeric diisocyanate,
   wherein the at least one monomeric diisocyanate and the at least one polyol are used in an amount such that the NCO/OH equivalent ratio is from 1.5:1 to 25:1, preferably from 2:1 to 20:1.

The at least one polyol comprises one or more hydroxyl groups per molecule and can be any suitable polyol to obtain an isocyanate-terminated prepolymer according to the invention. The at least one polyol may comprise an individual polyol or a mixture of two or more polyols.

The at least one polyol preferably has an average number-average molecular weight Mₙ of from 60 to 20000 g/mol, preferably from 60 to 8000 g/mol, more preferably from 60 to 4000 g/mol. In case one individual polyol is applied, the individual polyol preferably has a number-average molecular weight Mₙ of from 60 to 20000 g/mol, preferably from 60 to 8000 g/mol, more preferably from 60 to 4000 g/mol. In case a mixture of two or more polyols are applied, the mixture of polyols preferably has a number-average molecular weight Mₙ of from 60 to 20000 g/mol, preferably from 60 to 8000 g/mol, more preferably from 60 to 4000 g/mol.

The at least one polyol preferably has an average OH functionality from 2 to 8, preferably from 2 to 6, more preferably from 2 to 4. In case one individual polyol is applied, the individual polyol preferably has an OH functionality from 2 to 8, preferably from 2 to 6, more preferably from 2 to 4. In case a mixture of two or more polyols are applied, the mixture of polyols preferably has an average OH functionality from 2 to 8, preferably from 2 to 6, more preferably from 2 to 4. The concept of the OH functionality is familiar to the skilled person. It indicates the number of OH groups (hydroxyl groups) that are present on average per molecule. Pure diols have an OH functionality of 2.0. The OH functionality of a polyol is given by the supplier of the polyol and can be determined by the functionality of the components used to prepare the polyol.

The at least one polyol is preferably selected from the group consisting of polyester polyols, polyether polyols, polyether polyester polyols, polycarbonate polyols, polyether polycarbonate polyols, polyether polyester polycarbonate polyols and mixtures thereof. In principle, these polyols are known to the person skilled in the art.

Polyester polyols are obtained in a manner known per se by reacting polyhydric alcohols, for example those with from 2 to 14 carbon atoms, with substoichiometric amounts of polycarboxylic acids, corresponding carboxylic acid anhydrides, corresponding polycarboxylic acid anhydrides lower alcohols or lactones.

The acids or acid derivatives used for the preparation of the polyester polyols may be aliphatic, cycloaliphatic and/or aromatic and may be optionally substituted and/or unsaturated, for example by halogen atoms. Examples of suitable acids are polybasic carboxylic acids having a molecular weight of 118 to 300 g/mol or derivatives thereof, such as succinic acid, adipic acid, sebacic acid, phthalic acid, isophthalic acid, trimellitic acid, phthalic anhydride, tetrahydrophthalic acid, maleic acid, maleic anhydride, dimeric and trimeric fatty acids, dimethyl terephthalate and bis-glycol terephthalic acid esters.

Any desired mixtures of these starting compounds mentioned by way of example may also be used for the preparation of the polyester polyols.

Preferred polyester polyols are polycaprolactone polyols.

Polyhydroxyl compounds of the polycarbonate type which are suitable are the polycarbonate polyols known per se, such as can be prepared, for example, by reacting dihydric alcohols, having a molecular weight range of 62 to 400 g/mol, with diaryl carbonates, such as, for example, diphenyl carbonate, dialkyl carbonates, such as, for example, dimethyl carbonate, or phosgene.

Suitable polyether polyols are, in particular, as are obtainable in a manner known per se by alkoxylation of suitable starter molecules. To prepare these polyether polyols, any desired polyhydric alcohols, such as the simple polyhydric alcohols having 2 to 14 carbon atoms, can be used as starter molecules. Aliphatic and/or aromatic amines are also suitable starter molecules. Alkyl oxides suitable for the alkoxylation reaction are, in particular, ethylene oxide and propylene oxide, which can be used in any desired sequence or else in a mixture in the alkoxylation reaction.

Suitable polyether polyols are also the polyoxytetramethylene glycols known per se, by polymerization of tetrahydrofuran.

Suitable polyether polyester polyols are for example those obtained by the addition of epoxies to the esterification product of an aromatic dicarboxylic acid derivative and a difunctional or higher-functional alcohol.

The at least one polyol is preferably selected from the group consisting of polyester polyols, polyether polyols, and mixtures thereof. The at least one monomeric diisocyanate can be any suitable diisocyanate, meaning that any compound which includes two isocyanate groups is within the contemplation of the present invention. Aliphatic, cycloaliphatic or aromatic diisocyanates may in principle be used. Examples of aromatic diisocyanates are toluene-2,4-diisocyanate, toluene-2,6-diisocyanate, 4,4′-diphenylmethane diisocyanate, 2,4′-diphenylmethane diisocyanate, 2,2′-diphenylmethane diisocyanate, polymeric or oligomeric diphenylmethane diisocyanate, 1,5-napthalene diisocyanate and mixtures thereof. Aliphatic diisocyanates and cycloaliphatic diisocyanates are preferred.

The at least one monomeric diisocyanate is preferably an aliphatic diisocyanate and/or a cycloaliphatic diisocyanate. Accordingly, the isocyanate-terminated prepolymer is preferably obtained or obtainable by reaction of
(I) At least one polyol, with a stoichiometric excess of
(II) At least one monomeric aliphatic diisocyanate and/or at least one monomeric cycloaliphatic diisocyanate.

An aliphatic diisocyanate is a compound in which the two isocyanate groups are directly bonded to an aliphatic hydrocarbon group, irrespective of whether aromatic groups are present in the compound. The term “aliphatic hydrocarbon group” refers to optionally branched alkyl, alkenyl and alkynyl group. A cycloaliphatic diisocyanate is a compound in which one or more isocyanate groups are directly bonded to a cycloaliphatic hydrocarbon group, irrespective of whether aromatic groups are present in the compound. The term “cycloaliphatic hydrocarbon group” refers to cycloalkyl and cycloalkenyl group optionally substituted with at least one aliphatic hydrocarbon group.

The aliphatic diisocyanate is preferably selected from the group consisting of 1,5-diisocyanatopentane, 1,6-diisocyanatohexane, 2,2,4-trimethyl hexamethylene diisocyanate, 2,4,4-trimethyl hexamethylene diisocyanate, 1,3-xylylene diisocyanate, 1,3-tetramethylxylene diisocyanate and mixtures thereof. More preferably, the aliphatic diisocyanate is selected from the group consisting of 1,5-diisocyanatopentane, 1,6-diisocyanatohexane, 2,2,4-trimethyl hexamethylene diisocyanate, 2,4,4-trimethyl hexamethylene diisocyanate and mixtures thereof.

The cycloaliphatic diisocyanate is preferably selected from the group consisting of isophorone diisocyanate (IPDI), 1-isocyanato-4-[(4-isocyanatocyclohexyl)methyl]-cyclohexane (H₁₂MDI), 1,3-bis(isocyanatomethyl)cyclohexane and mixtures thereof.

More preferably, the diisocyanate is selected from the group consisting of 1,5-diisocyanatopentane, 1,6-diisocyanatohexane, isophorone diisocyanate and mixtures thereof.

In principle, but this is not necessary, the inventive NCO-terminated prepolymer can be diluted with a solvent inert toward isocyanate groups and preferably also toward the other reactive groups of the starting components. Suitable solvents are, for example, ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, more highly substituted aromatics, of the kind available commercially, for example, under the names Solventnaphtha, Solvesso®, Isopar®, Nappar®, Varsol® (ExxonMobil Chemical Central Europe, Cologne, Germany) and Shellsol® (Shell Deutschland Oil GmbH, Hamburg, Germany), and also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

The invention further relates to a process for preparing the inventive NCO-terminated prepolymer comprising the following steps
a) mixing at least one polyol with an excess of at least one monomeric diisocyanate at a temperature suitable to form urethane groups,
b) optionally partly or fully allophanatizing the urethane groups by further reaction with at least one monomeric diisocyanate (which may be different from those from (a)) optionally in the presence of a catalyst,
c) removal of the excess of the monomeric diisocyanate, if present, by distillation down to <0.2% by weight, preferably down to <0.1% by weight, based on the total solid content of the NCO-terminated prepolymer, to obtain the isocyanate-terminated prepolymer, and
d) optionally addition of at least one solvent inert towards isocyanate groups.

Preferably, the process of the invention comprises the following steps
a) mixing at least one polyol with an excess of at least one monomeric diisocyanate,
b) partly or fully allophanatizing the urethane groups by further reaction with at least one monomeric diisocyanate (which may be different from those from (a)),
c) removal of the excess of the monomeric diisocyanate, if present, by distillation down to <0.2% by weight, preferably down to <0.1% by weight, based on the NCO-terminated prepolymer, to obtain the isocyanate-terminated prepolymer, and
d) optionally addition of at least one solvent inert towards isocyanate groups.

The at least one monomeric diisocyanate is preferably reacted with the at least one polyol at temperatures of 20 to 200° C., preferably 40 to 160° C., more preferably 60 to 140° C. Preferably, in step a) at least one polyol is added to a heated excess of at least one monomeric diisocyanate.

The process of the invention can be conducted without catalysis. If necessary, however, suitable catalysts can also be used to accelerate the urethanization reaction and if present the allophanatization reaction. In case (cyclo)aliphatic diisocyanates are used, step b) is preferably effected in the presence of a catalyst.

Catalysts suitable to accelerate the urethanization reaction are the conventional catalysts known from polyurethane chemistry, for example tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl-/N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylamino-piperazine, 1,8-diazabicyclo[5.4.0]undec-7-ene (DBU), 1,2-dimethylimidazole, 2-methylimidazole, N,N-dimethylimidazole-β-phenylethylamine, 1,4-diazabicyclo-[2.2.2]octane, bis(N,N-dimethylaminoethyl) adipate; alkanolamine compounds, for example triethanolamine, triisopropanolamine, N-methyl- and N-ethyldiethanolamine, dimethylaminoethanol, 2-(N,N-dimethylaminoethoxy)ethanol, N,N′,N″-tris(dialkylamino-alkyl)hexahydrotriazines, for example N,N′,N″-tris(dimethylaminopropyl)-s-hexahydro-triazine and/or bis(dimethylaminoethyl) ether; metal salts, for example inorganic and/or organic compounds of iron, lead, bismuth, zinc and/or tin in customary oxidation states of the metal, for example iron(II) chloride, iron(III) chloride, bismuth(III) bismuth(III) 2-ethyl-hexanoate, bismuth(III) octoate, bismuth(III) neodecanoate, zinc chloride, zinc 2-ethyl-caproate, tin(II) octoate, tin(II) ethylcaproate, tin(II) palmitate, dibutyltin(IV) dilaurate (DBTL), dibutyltin(IV) dichloride or lead octoate; amidines, for example 2,3-dimethyl-3,4,5,6-tetrahydropyrimidine; tetraalkylammonium hydroxides, for example tetramethylammonium hydroxide; alkali metal hydroxides, for example sodium hydroxide, and alkali metal alkoxides, for example sodium methoxide and potassium isopropoxide, and also alkali metal salts of long-chain fatty acids having 10 to 20 carbon atoms and optionally lateral OH groups. Catalysts suitable to accelerate the allophanation reaction are known in the art ant are for example based on Zn or Zr such as: Zirconiumoctoate or Zinc(II)ethylhexanoate.

These catalysts are used in the process of the invention, if at all, preferably in an amount of 0.001% to 5% by weight, more preferably 0.005% to 1% by weight, based on the total weight of all co-reactants, and may be added either before the beginning of the reaction or at any time during the reaction.

The progress of the reaction in the process of the invention can be monitored by determining the NCO content by titrimetric means, for example as per DIN EN ISO 11909:2007-05. On attainment of the desired NCO content, preferably when the NCO content corresponding in theoretical terms to complete conversion of isocyanate and hydroxyl groups has been attained in the reaction mixture, any urethanization catalysts used are preferably deactivated by addition of suitable catalyst poisons.

Such catalyst poisons are, for example, inorganic acids such as hydrochloric acid, phosphorous acid or phosphoric acid, acid chlorides such as acetyl chloride, benzoyl chloride or isophthaloyl chloride, sulfonic acids and sulfonic esters, such as methanesulfonic acid, p-toluenesulfonic acid, trifluoromethanesulfonic acid, perfluorobutanesulfonic acid, dodecylbenzenesulfonic acid, methyl and ethyl p-toluenesulfonate, mono- and dialkyl phosphates such as monotridecyl phosphate, dibutyl phosphate and dioctyl phosphate, but also silylated acids such as trimethylsilyl methanesulfonate, trimethylsilyl trifluoromethanesulfonate, tris(trimethylsilyl) phosphate and diethyl trimethylsilyl phosphate.

The amount of catalyst poison required for deactivation of the catalyst is guided by the amount of the catalyst used. In general, an equivalent amount of the catalyst poison is used, based on the urethanization catalyst used at the start. If, however, any catalyst losses that occur during the reaction are taken into account, even 20 to 80 equivalent % of the catalyst poison, based on the amount of catalyst originally used, may be sufficient to stop the reaction.

The process of the invention is preferably conducted without solvent. If desired, however, suitable solvents inert toward the reactive groups of the starting components can also be used. Suitable solvents are, for example, the customary paint solvents that are known per se such as ethyl acetate, butyl acetate, ethylene glycol monomethyl or monoethyl ether acetate, 1-methoxyprop-2-yl acetate, 3-methoxy-n-butyl acetate, acetone, 2-butanone, 4-methyl-2-pentanone, cyclohexanone, toluene, xylene, chlorobenzene, white spirit, more highly substituted aromatics, of the kind available commercially, for example, under the names Solventnaphtha, Solvesso®, Isopar®, Nappar®, Varsol® (ExxonMobil Chemical Central Europe, Cologne, Germany) and Shellsol® (Shell Deutschland Oil GmbH, Hamburg, Germany), and also solvents such as propylene glycol diacetate, diethylene glycol dimethyl ether, dipropylene glycol dimethyl ether, diethylene glycol ethyl and butyl ether acetate, N-methylpyrrolidone and N-methylcaprolactam, or any desired mixtures of such solvents.

Independent of the optional use of a solvent in step a) or b) the inventive process comprise the optional step d) of addition of at least one solvent inert towards isocyanate groups to reach a preferred viscosity of <2000 mPas at 23° C. measured to DIN EN ISO 3219:1994-10. Such optional solvent is preferably selected from the beforementioned list. In case step d) is conducted, a suitable solvent is preferably added in an amount to achieve a solids content of >50% by weight, more preferably a solids content of >80% by weight and most preferred a solids content of >95% by weight.

The inventive NCO-terminated prepolymer is especially suitable for use in curable compositions for coating, adhesive, sealant and/or foam systems, which is a further aspect of the present invention. Since the inventive NCO-terminated prepolymers have reduced skin sensitisation potential or even have no skin sensitisation potential, the NCO-terminated prepolymers can very advantageously be applied for reducing and/or avoiding any concerns for skin sensitization effects on the persons which may become exposed to said isocyanate-terminated prepolymers. Therefore, the inventive NCO-terminated prepolymers can very advantageously be applied in particular in curable compositions for coating, adhesive, sealant and/or foam systems that are applied manually. All embodiments described or preferred for one subject of the present invention, e.g. the inventive NCO-terminated prepolymer are also described or preferred for the other subject of the present invention, like the use subject matter of the present invention, and can be combined freely unless the context does clearly show the opposite. The invention further relates to the use of lysine mean depletion value in the modified Direct Peptide Reactivity Assay (DPRA) to determine the skin sensitization potential of an isocyanate-terminated prepolymer, wherein preferably a lysine mean depletion in the test of ≤1.00% reflects reduced skin sensitization potential or no skin sensitization potential.

A preferred coating system is a refinish coating system, in particular an automotive refinish coating system.

The sealant and/or foam systems can very suitable be applied in the building industry, for example for insulation purpose and/or for filling cavities.

The present invention further relates to a coating system, an adhesive system, a sealant system or a foam system, in particular for manual application, comprising the inventive isocyanate-terminated prepolymer.

The invention further pertains to a moisture-curable one-component system comprising at least one isocyanate-terminated prepolymer according to the invention, in particular to a moisture-curable one-component coating, adhesive, sealant or foam system comprising at least one isocyanate-terminated prepolymer according to the invention, more in particular the one-component system is a one-component foam system, in particular a one-component foam system for application in the building industry, in particular for manual application in the building industry.

The invention further pertains to a two-component system, comprising a component A), comprising at least one isocyanate-terminated prepolymer according to the invention, and a component B), comprising at least one compound which comprises at least one Zerewitinoff-active group. The two-component system is in particular a two-component coating system, a two-component adhesive system, a two-component sealant system or a two-component foam system, in particular for manual application. In a preferred embodiment, the two-component system is a sealant system or an adhesive system, in particular for manual application in the building industry. In another preferred embodiment, the two-component system is a refinish coating system, in particular an automotive refinish system.

Suitable compounds which comprises at least one Zerewitinoff-active group are, for example, the conventional polymeric polyether polyols, polyester polyols, polycarbonate polyols and/or polyacrylate polyols known from polyurethane chemistry, which usually have a number-average molecular weight of from 200 to 22,000, preferably from 250 to 18,000, particularly preferably from 250 to 12,000. A broad overview of suitable polymeric polyols can be found, for example, in N. Adam et al.: “Polyurethanes”, Ullmann's Encyclopedia of Industrial Chemistry, Electronic Release, 7th ed., chap. 3.2-3.4, Wiley-VCH, Weinheim 2005.

As an alternative to the abovementioned hydroxy-functional compounds, polyamines, such as, for example, the polyaspartic acid derivatives known from EP-B 0 403 921, or also those polyamines whose amino groups are present in blocked form, such as, for example, polyketimines, polyaldimines or oxazolanes, are also suitable as isocyanate-reactive binders. Free amino groups are formed from these blocked amino groups under the influence of moisture and, in the case of the oxazolanes, also free hydroxyl groups which react with crosslinking with the isocyanate groups of the diisocyanate. In a preferred embodiment, the at least one compound, which comprises at least one Zerewitinoff-active group, is selected from polyester polyols, polyether polyols, polyurethane polyols, polyacrylate polyols, polymethacrylate polyols, polycarbonate polyols and mixtures thereof.

Said component B) preferably comprises less than 5% by weight, preferably less than 2% by weight, more preferably less than 1% by weight of solvent. This has the advantage to further improve the economic and working safety properties because the volatile organic emissions are significantly reduced without negatively affecting the performance of the inventive two-component-systems.

If appropriate, further auxiliaries and additives customary in the coating, adhesive, sealant or foam sector can be added to the system. Examples of suitable auxiliaries and additives are leveling auxiliaries, color pigments, filler materials, matting agents, inorganic or organic pigments, light stabilizers, lacquer additives, such as dispersants, leveling agents, thickeners, antifoams and other auxiliaries, adhesives, fungicides, bactericides, stabilizers or inhibitors and catalysts or emulsifiers.

The invention further relates to a process for curing a moisture-curable one-component system on a substrate or in a cavity, comprising the following steps
i) applying on at least one substrate or in a cavity at least one inventive moisture-curable one-component system and
ii) exposing the deposited composition to a temperature of 0 to 120° C., preferably of 20 to 90° C. and more preferred of 20 to 60° C. to cure said deposited composition.

The invention further relates to a process for curing a two-component system on a substrate or in a cavity, comprising the following steps
i. just prior to applying the two-component system on at least one substrate or in a cavity, mixing component A) and component B) of the two-component-system to obtain a mixture,
ii. applying on at least one substrate or in the cavity said mixture, and
iii. exposing the deposited composition to a temperature of 0 to 120° C., preferably of 20 to 90° C. and more preferred of 20 to 60° C. to cure said deposited composition.

Upon curing of the deposited composition, the cured composition forms a solid on the substrate or in the cavity. In case the system is deposited on at least one substrate, such solid is preferably a coating or an adhesive. In case of being an adhesive, it is preferred to add a second substrate in a further step between step i. and ii. or between ii. and iii. or to add such second substrate directly in step i. or in step ii. In case the system is deposited in a cavity, such solid is preferably a sealant or a foam.

Substrates suitable for the coatings, adhesives and/or sealants formulated using the inventive NCO-terminated prepolymers or the inventive moisture-curable one-component system or the inventive two-component-system include any desired substrates, such as, for example, metal, wood, glass, stone, ceramic materials, concrete, rigid and flexible plastics, textiles, leather, and paper, which prior to coating may optionally also be provided with customary primers.

The invention further pertains to a cured article obtainable or obtained by the inventive process for curing a moisture-curable one-component system or a two-component system composition on a substrate or in a cavity. In one preferred embodiment, the cured composition is a refinish coating and the substrate is a refinish substrate. In this embodiment, the cured composition is preferably an automotive refinish coating and the substrate is a refinish automotive substrate. In another preferred embodiment, the cured composition is a foam or sealant in a building house.

A further aspect of the present invention is the use of either the inventive NCO-terminated prepolymer or the inventive moisture-curable one-component system or the inventive two-component-system for coatings, especially in automotive repair applications or for foams and/or sealants, especially in the building industry.

The present invention in particular pertains to the following embodiments:

According to a first embodiment, the invention relates to an isocyanate-terminated prepolymer obtained by reaction of
(I) At least one polyol, with a stoichiometric excess of
(II) At least one monomeric diisocyanate,
wherein the isocyanate-terminated prepolymer has
i. a functional group equivalent weight FGEW of ≥560 g/mol,
ii. a content of residual non-reacted monomeric diisocyanate of <0.2% by weight.

According to a second embodiment, the invention relates to the isocyanate-terminated prepolymer according to the first embodiment, wherein the isocyanate-terminated prepolymer has a functional group equivalent weight FGEW of ≥600 g/mol, preferably ≥650 g/mol, more preferably ≥700 g/mol, even more preferably ≥800 g/mol, even more preferably ≥1000 g/mol.

According to a third embodiment, the invention relates to the isocyanate-terminated prepolymer according to the first or second embodiment, wherein the isocyanate-terminated prepolymer has a functional group equivalent weight FGEW of ≤10000 g/mol, preferably ≤4000 g/mol, more preferably ≤2000 g/mol.

According to a fourth embodiment, the invention relates to the isocyanate-terminated prepolymer according to any one of the preceding embodiments, wherein the at least one polyol has an average number-average molecular weight Mn of from 60 to 20000 g/mol, preferably from 60 to 8000 g/mol, more preferably from 60 to 4000 g/mol.

According to a fifth embodiment, the invention relates to the isocyanate-terminated prepolymer according to any one of the preceding embodiments, wherein the at least one polyol is selected from the group consisting of polyester polyols, polyether polyols, polyether polyester polyols, polycarbonate polyols, polyether polycarbonate polyols, polyether polyester polycarbonate polyols and mixtures thereof.

According to a sixth embodiment, the invention relates to the isocyanate-terminated prepolymer according to any one of the preceding embodiments, wherein the at least one polyol has an average OH functionality from 2 to 8, preferably from 2 to 6, more preferably from 2 to 4.

According to a seventh embodiment, the invention relates to the isocyanate-terminated prepolymer according to any one of the preceding embodiments, wherein the isocyanate-terminated prepolymer has a monomeric diisocyanate content of <0.1% by weight.

According to an eighth embodiment, the invention relates to the isocyanate-terminated prepolymer according to any one of the preceding embodiments, wherein the isocyanate-terminated prepolymer contains urethane groups and/or allophanate groups and optionally functional groups selected from the group consisting of urea groups, biuret groups, uretdione groups, carbodiimide groups, uretonimine groups, isocyanurate groups and any combination thereof.

According to a ninth embodiment, the invention relates to the isocyanate-terminated prepolymer according to any one of the preceding embodiments, wherein the isocyanate-terminated prepolymer is the reaction product of
(I) At least one polyol, and
(II) At least one monomeric diisocyanate,
wherein the at least one monomeric diisocyanate and the at least one polyol are used in an amount such that the NCO/OH equivalent ratio is from 1.5:1 to 25:1, preferably from 2:1 to 20:1.

According to a tenth embodiment, the invention relates to the isocyanate-terminated prepolymer according to any one of the preceding embodiments, wherein the at least one monomeric diisocyanate is an aliphatic diisocyanate and/or a cycloaliphatic diisocyanate.

According to a eleventh embodiment, the invention relates to the isocyanate-terminated prepolymer according to embodiment ten, wherein the aliphatic diisocyanate is selected from the group consisting of 1,5-diisocyanatopentane, 1,6-diisocyanatohexane, 2,2,4-trimethyl hexamethylene diisocyanate, 2,4,4-trimethyl hexamethylene diisocyanate and mixtures thereof.

According to a twelfth embodiment, the invention relates to the isocyanate-terminated prepolymer according to embodiment ten or eleven, wherein the cycloaliphatic diisocyanate is selected from the group consisting of isophorone diisocyanate, 1-isocyanato-4-[(4-isocyanatocyclohexyl)methyl]cyclohexane (H12MDI), 1,3-bis(isocyanatomethyl)cyclohexane and mixtures thereof.

According to a thirteenth embodiment, the invention relates to the isocyanate-terminated prepolymer according to any one of the preceding embodiments, wherein the diisocyanate is selected from the group consisting of 1,5-diisocyanatopentane, 1,6-diisocyanatohexane, isophorone diisocyanate and mixtures thereof.

According to a fourteenth embodiment, the invention relates to a process for preparing the isocyanate-terminated prepolymer according to any one of the preceding embodiments, comprising the following steps
a) mixing at least one polyol with an excess of at least one monomeric diisocyanate,
b) optionally partly or fully allophanatizing the urethane groups by further reaction with at least one monomeric diisocyanate (which may be different from those from (a)),
c) removal of the excess of the monomeric diisocyanate, if present, by distillation down to <0.2% by weight, preferably down to <0.1% by weight, based on the NCO-terminated prepolymer, to obtain the isocyanate-terminated prepolymer, and
d) optionally addition of at least one solvent inert towards isocyanate groups.

According to a fifteenth embodiment, the invention relates to the process according to embodiment fourteen, comprising the following steps
a) mixing at least one polyol with an excess of at least one monomeric diisocyanate,
b) partly or fully allophanatizing the urethane groups by further reaction with at least one monomeric diisocyanate (which may be different from those from (a)),
c) removal of the excess of the monomeric diisocyanate, if present, by distillation down to <0.2% by weight, preferably down to <0.1% by weight, based on the NCO-terminated prepolymer, to obtain the isocyanate-terminated prepolymer, and
d) optionally addition of at least one solvent inert towards isocyanate groups.

According to a sixteenth embodiment, the invention relates to a use of the isocyanate-terminated prepolymer according to any one of the embodiments one to thirteen or obtained with the process according to embodiment fourteen or fifteen as an isocyanate-terminated prepolymer with reduced skin sensitization potential or no skin sensitization potential.

According to a seventeenth embodiment, the invention relates to a use of the isocyanate-terminated prepolymer according to any one of the embodiments one to thirteen or obtained with the process according to embodiment fourteen or fifteen in curable compositions for a coating system, an adhesive system, a sealant system and/or a foam system, in particular those systems which are applied manually.

According to an eighteenth embodiment, the invention relates to the use according to embodiment seventeen for reducing the skin sensitisation of a coating system, an adhesive system, a sealant system and/or a foam system, in particular for reducing the skin sensitisation of a coating system, an adhesive system, a sealant system and/or a foam system that is applied manually.

According to a nineteenth embodiment, the invention relates to the use according to embodiment seventeen or eighteen, wherein the coating system is a refinish coating system, in particular an automotive refinish coating system.

According to a twentieth embodiment, the invention relates to the use according to embodiment seventeen or eighteen, wherein the curable composition is applied in a sealant and/or a foam system, in particular in a sealant and/or a foam system that is applied in the building industry.

According to a twenty-first embodiment, the invention relates to a coating, adhesive, sealant or foam system in particular for manual application comprising the isocyanate-terminated prepolymer according to any one of the embodiments one to thirteen or obtained with the process according to embodiments fourteen or fifteen.

According to a twenty-second embodiment, the invention relates to a two-component system, comprising a component A), comprising at least one isocyanate-terminated prepolymer according to any one of the embodiments one to thirteen or obtained with the process according to embodiments fourteen or fifteen, and a component B), comprising at least one compound which comprises at least one Zerewitinoff-active group.

According to a twenty-third embodiment, the invention relates to a two-component system according to embodiment twenty-two, characterized in that the two-component system is a coating system, a sealant system, a foam system or an adhesive system, in particular for manual application.

According to a twenty-fourth embodiment, the invention relates to a two-component system according to embodiment twenty-two, characterized in that the two-component system is a refinish coating system, in particular an automotive refinish system.

According to a twenty-fifth embodiment, the invention relates to a moisture-curable one-component system comprising at least one isocyanate-terminated prepolymer according to any one of the embodiments one to thirteen or obtained with the process according to embodiments fourteen or fifteen.

According to a twenty-sixth embodiment, the invention relates to a moisture-curable one-component system according to embodiment twenty-five, wherein the one-component system is a one-component foam system, in particular a one-component foam system for application in the building industry.

The present invention is illustrated by reference to examples, although these are not to be understood as being limiting. All percentages are based on weight, unless stated otherwise.

### EXAMPLES AND COMPARATIVE EXPERIMENTS

### Raw Materials Applied

Desmodur® H (monomeric aliphatic diisocyanate), Covestro Germany.
Desmodur® I (monomeric aliphatic diisocyanate), Covestro Germany.
Desmodur® 2460 MDI (monomeric aromatic diisocyanate), Covestro Germany.
Desmodur® T 80 (monomeric aromatic diisocyanate), Covestro Germany.
2-Ethylhexanol was received from Sigma Aldrich.
Octa-Soligen® Zirconium 18 (Zirconiumoctoate) was received from Borchers.
Zinc(II)-ethylhexanoate was received from abcr GmbH.
Isophthalolychlorid was received from Acros Organics.
Dibutylphosphate was received from Acros Organics.

### Polyol Types:

### Polyol 1

Polyetherpolyol based on propylene oxide and propylene glycol.
OH functionality: F=2
Mₙ=200 g/mol

### Polyol 2

Linear polyetherpolyol based on propylene oxide and propylene glycol.
OH functionality: F=2
Mₙ=431 g/mol

### Polyol 3

Linear polyetherpolyol based on propylene oxide and propylene glycol.
OH functionality: F=2
Mₙ=1000 g/mol

### Polyol 4

Polyesterpolyol based on monoethylene glycole and phthalic anhydride.
OH functionality: F=2
Mₙ=390 g/mol

### Polyol 5

Linear polyetherpolyol based on propylene oxide and propylene glycol.
OH functionality: F=2
Mₙ=2000 g/mol

### Polyol 6

Polycaprolactone based on diethylene glycol received from Ingevity
OH functionality: F=2
Mₙ=830 g/mol

### Polyol 7

Linear polyesterpolyol based on adipic acid, phthalic anhydride, diethylene glycol and monoethylene glycol. Low molecular weight oligomers were removed by distillation at 195° C. and a pressure of 0.2-0.5 mbar.
OH functionality: F=2
Mₙ=571 g/mol

### Polyol 8

Linear polyesterpolyol based on neopentyl glycol, monoethylene glycol and adipic acid.
OH functionality: F=2
Mₙ=500 g/mol

### Polyol 9

Linear polyesterpolyol based on diethylene glycol, 1,4-butanediol, monoethylene glycol and adipic acid.
OH functionality: F=2
Mₙ=2120 g/mol

### Polyol 10

Polycaprolactone based on butanediol received from Ingevity
OH functionality: F=2
Mₙ=400 g/mol

### Polyol 11

Branched polyester based on trimethylolpropane, neopentyl glycol, 1,3-butanediol and isophthalic acid. Low molecular weight oligomers were removed by distillation at 195° C.
OH functionality: F=3.4
Mₙ=740 g/mol

### Polyol 12

Polycaprolactone based on trimethylolpropane received from Ingevity.
OH functionality: F=3
Mₙ=2000 g/mol

### Polyol 13

Branched polyether based on glycerol and propylene oxide.
OH functionality: F=3
Mₙ=714 g/mol

### Polyol 14

Linear polyetherpolyol based on propylene glycole and propylene oxide.
OH functionality: F=2
Mₙ=1000 g/mol

### Methods

All percentages are based on weight, unless stated otherwise.

The NCO contents were determined by titrimetry as per DIN EN ISO 11909:2007-05.

The residual diisocyanate monomer contents were measured to DIN EN ISO 10283:2007-11 by gas chromatography with an internal standard.

All the viscosity measurements were made with a Physica MCR 51 rheometer from Anton Paar Germany GmbH (Germany) to DIN EN ISO 3219:1994-10 at a shear rate of 250 s-1.

The content of oligomers having a number average molecular weight≤1000 g/mol is determined via gel permeation chromatography (GPC) at 23° C. in tetrahydrofuran as the solvent. The measurement is performed as described in DIN 55672-1:2016-03: “Gelpermeationschromatographie, Teil 1—Tetrahydrofuran als Elutionsmittel” (SECurity GPC-System from PSS Polymer Service, flowrate 1.0 ml/min; columns: 2×PSS SDV linear M, 8×300 mm, 5 μm; RID-detector). Samples of polystyrene standards of known molecular weight were used for calibration. The calculation of the number average molecular weight was performed by software. Baseline values and evaluation threshold values were determined according to above referenced DIN 55672-1.

The functional group equivalent weight (FGEW) refers to the number average molecular weight per isocyanate functional group, and is a value obtained by dividing the number average molecular weight (Mₙ) of the isocyanate terminated prepolymer, obtained via Gelpermeation Chromatography, by the average number of isocyanate groups per molecule (NCO functionality).

The NCO functionality of the prepared urethane prepolymer equals the OH functionality of the polyol used as raw material.

The OH functionality of the polyol is given by the supplier of the polyol and can be determined by the functionality of the components used to prepare the polyol.

The NCO functionality of the prepared allophanate prepolymer Fₐₗₗₒₚₕₐₙₐₜₑ is calculated via the polyol functionality F_{polyol} with respect to allophanate content of the respective prepolymer as determined via ¹³C NMR.

$${F}_{Allophanate} = 2 * {F}_{Polyol} * \frac{allophanate content}{100}$$

Analysis of allophanate content of the prepared prepolymer is done via ¹³C NMR. ¹³C NMR shifts of allophanate moieties in CDCl₃ are found at δ₁=153.8 ppm and δ₂=155.7 ppm with a ratio of 1:1 in case of 100% allophanate formation. However, during the synthesis of allophanates not all urethane groups might be converted into allophanate moieties. Here, the amount of allophanate in a prepolymer can be calculated via the ratio of the integrals of δ₁ and δ₂.

The modified Direct Peptide Reactivity Assays test (modified DPRA test) was done according to the OECD guideline 442C (OECD (2021), Test No. 442C: In Chemico Skin Sensitisation: Assays addressing the Adverse Outcome Pathway key event on covalent binding to proteins, OECD Guidelines for the Testing of Chemicals, Section 4, OECD Publishing, Paris, https://doi.org/10.1787/9789264229709-en). Only the lysine depletion was tested. The test determines the depletion of a synthetic peptide containing lysine due to the reaction with the potential skin sensitizer. The lysine depletion in percent is the loss of lysine containing peptide, determined by HPLC/UV, compared with the control.

For this invention the potential skin sensitizer is the low monomer isocyanate terminated prepolymer or a diisocyanate, that might be present in the low monomer isocyanate terminated prepolymer as residual diisocyanate after the thin-film-distillation.

The method “Local Lymph Node Assay” (LLNA) is specified in EPA guideline OPPTS 870.2600, Skin Sensitization, March 2003; updated OECD TG 429, 2010 for the assessment of skin sensitization.

The modified Local Lymph Node Assays (IMDS) are performed on 24 female NMRI mice (6 animals/test item group and 6 control animals) to determine if there is any specific (sensitizing) or non-specific (irritant) stimulating potential of the test items. In addition, concurrent positive groups with 6 animals treated with Alpha Hexyl Cinnamic Aldehyde are examined.

The modifications in the IMDS (Integrated Model for the Differentiation of Skin reactions) in comparison to the classical LLNA refer to the measurement of cell proliferation by cell counting instead of radioactive labeling. In addition, the acute inflammatory skin reaction (ear swelling I ear weight) is determined to discriminate specific from non-specific activation of immune competent cells in the draining lymph nodes, as also recommended in the update of OECD TG 429.

### Route of Administration and Dosage:

The test items in formulation, or the vehicle are applied epicutaneously onto the dorsal part of both ears of the animals. This treatment is repeated on three consecutive days (d1, d2 and d3).

The volume administered is 25 μl/ear.

### Autopsies:

The animals are anaesthetized by inhalation of carbon dioxide and sacrificed one day after the last application (day 4). The appropriate organs are then removed. The lymphatic organs (the auricular lymph nodes) are transferred into physiological saline (PBS).

### Calculation of Indices:

The weight and cell count determinations are carried out by appropriate laboratory procedures. The so-called stimulation (or LLN-) index is calculated by dividing the absolute number of weight or cell counts of the substance treated lymph nodes by the vehicle treated ones.

Before the first treatment and before sacrifice the thickness of both auricles of the animals is measured using a spring-loaded micrometer. The corresponding index is calculated by dividing the ear thickness of the substance treated ears by that of the ears treated with the vehicle.

On day 4 of the study the ear weight of the sacrificed animals is measured using a punch to take a piece of every ear with a diameter of 8 mm. The corresponding index is calculated by dividing the ear weight of the substance treated ears by that of the ears treated with the vehicle.

A compound has a negative Local Lymph Node Assay (LLNA) when the compound has a Stimulation Index (SI value) of less than 3. A compound having a SI value of less than 3 is considered negative for skin sensitisation.

A correlation between negative Local Lymph Node Assays (LLNA) and negative modified Direct Peptide Reactivity Assays (DPRA) have been found. Details are shown in Table 3.

### EXAMPLES

### Procedure for the Synthesis of Urethane Prepolymers

A 5 to 15 fold excess of monomeric diisocyanate is heated to 70° C. to 100° C. under nitrogen. The respective polyol(s) are preheated to 60° C. to 80° C. if necessary and added sequentially under stirring to the monomeric diisocyanate via a dropping funnel. The mixture is stirred at 70° C. to 100° C. until the NCO content was indicative of a complete urethanization. Subsequently, excess monomeric diisocyanate is removed via thin film evaporation at a temperature of 110° C. to 185° C. and a pressure of 0.2-0.5 mbar. The product obtained is a NCO-terminated urethane prepolymer having analytical characteristics as listed in Table 1a and Table 1b.

### Procedure for the Synthesis of Allophanate Prepolymers

An 5 to 15 fold excess of monomeric aliphatic or cycloaliphatic diisocyanate is heated to 100° C. under nitrogen. The respective polyol is preheated to 80° C. if necessary and added under stirring to the monomeric diisocyanate via a dropping funnel. The mixture is stirred at 100° C. till the NCO content was indicative of a complete urethanization. To proceed with the allophanatization, 100 ppm catalyst is added as a 10 w % solution in 2-ethylhexanol to the mixture. The mixture is stirred at 90° C. to 110° C. until the final NCO content is reached. Subsequently, an equimolar amount of stopper is added as 10 w % solution in 2-ethylhexanol. Excess monomeric diisocyanate is then removed via thin film evaporation at a temperature of 115° C. to 120° C. and a pressure of 0.2-0.5 mbar. The product obtained is a NCO-terminated allophanate prepolymer having analytical characteristics as listed in Table 2.

Modified Direct Peptide Reactivity Assay (DPRA) tests have been performed using the synthesized prepolymers as described above. The resulting lysine mean depletion is listed in Tables 1a, 1b and 2.

TABLE 1a
Comparative Experiments A-G: NCO-terminated urethane prepolymers

| | | | | | | | | | | Monomeric | |
|---|---|---|---|---|---|---|---|---|---|---|---|
| | | | | | | Desmodur ® | Desmodur ® | Desmodur ® | Desmodur ® | Di- | |
| Polyol 13 | Polyol 8 | Polyol 7 | Polyol 2 | Polyol 1 | Polyol | T 80 | 2460M | I | H | isocyanate | |
| | | | | x | | | | | x | | CEx A |
| x (67.42 | | | | x (17.64 | | x | | | | | CEx B |
| w %) | | | | w %) | | | | | | | |
| | | | x | | | | | | x | | CEx C |
| | x | | | | | | | | x | | CEx D |
| | | | x | | | | | | x | | CEx E |
| | | x | | | | | | | x | | CEx F |
| | | | x | | | | | | x | | CEx G |

| | NCO | Monomeric | | Content | | | Analytical | NCO/OH | |
|---|---|---|---|---|---|---|---|---|---|
| Lysine mean | functionality | diisocyanate | FGEW | Mₙ < 1000 | Mₙ prepolymer | NCO | Charac- | equivalent | |
| depletion % | prepolymer | content | [g/mol] | g/mol | [g/mol] | content | teristics | ratio | Polyol 14 |
| 18 | 2 | 0.41% | 485.5 | 62.22% | 971 | 13% | | 5 | |
| 3 | 2.48 | 0.06 | 493.3 | 25.5% | 1223.4 | 10.9% | | 5 | x (14.94 |
| | | | | | | | | | w %) |
| 16 | 2 | 0.09% | 523 | 15.4% | 1046 | 10.8% | | 15 | |
| 7.5 | 2 | 0.07% | 535.5 | 39% | 1071 | 10.6% | | 15 | |
| 16 | 2 | 0.03% | 537.5 | 5.4% | 1075 | 10.8% | | 15 | |
| 2.31 | 2 | 0.04% | 546.5 | 24% | 1093 | 7.7% | | 15 | |
| 6.46 | 2 | 0.45% | 595 | 15.1% | 1190 | 9.7% | | 15 | |

TABLE 1b
Examples 1-7: NCO-terminated urethane prepolymers

| | | | | | | Desmodur ® | Desmodur ® | Desmodur ® | Monomeric | |
|---|---|---|---|---|---|---|---|---|---|---|
| Polyol 12 | Polyol 6 | Polyol 5 | Polyol 3 | Polyol 2 | Polyol | 2460M | I | H | Diisocyanate | |
| | | | | x | | | | x | | Ex 1 |
| | | | | x | | | x | | | Ex 2 |
| | x | | | | | | | x | | Ex 3 |
| x | | | | | | | | x | | Ex 4 |
| | | | x | | | | | x | | Ex 5 |
| | | | x (74.34 | x (25.66 | | x | | | | Ex 6 |
| | | | w %) | w %) | | | | | | |
| | | x | | | | | | x | | Ex 7 |

| | NCO | Monomeric | | Content | Mₙ | | | NCO/OH |
|---|---|---|---|---|---|---|---|---|
| Lysine mean | functionality | diisocyanate | FGEW | Mₙ < 1000 | prepolymer | NCO | Analytical | equivalent |
| depletion % | prepolymer | content | [g/mol] | g/mol | [g/mol] | content | Characteristics | ratio |
| 0.91 | 2 | 0.07% | 595 | 15.1% | 1190 | 9.7% | | 15 |
| 0 | 2 | 0.05% | 790 | 7.5% | 1580 | 7.1% | | 3 |
| 0 | 2 | 0.02% | 816.5 | 10.8% | 1633 | 7.1% | | 10 |
| 0 | 3 | 0.02% | 870.7 | 4.8% | 2612 | 5.2% | | 22.5 |
| 1 | 2 | 0.03% | 998 | 3.5% | 1996 | 5.9% | | 15 |
| 0 | 2 | 0.15% | 1046.5 | 0.5% | 2093 | 5.6% | | 5 |
| 0 | 2 | 0.02% | 1641.5 | 2.3% | 3283 | 3.3% | | 15 |

Comparative Experiments A-G show a lysine mean depletion of >1, leading to the conclusion that prepolymers having a functional group equivalent weight (FGEW) of <560 g/mol or a monomeric diisocyanate content of >0.2% (see comparative example G) independent of the FGEW will result in causing lysine mean depletion>1 in the described modified Direct Peptide Reactivity assay. Inventive examples 1 to 7 having FGEW>560 g/mol and monomeric diisocyanate content<0.2% show lysine mean depletion<1. Table 1b also shows that this behaviour is independent of the species of diisocyanate used.

TABLE 2
Comparative Experiments H-J and Examples 8-10: NCO-terminated allophanate prepolymers

| | | | | | |
|---|---|---|---|---|---|
| CEx H | CEx I | CEx J | Ex 8 | Ex 9 | Ex 10 |

Monomeric Diisocyanate

| | | | | | | |
|---|---|---|---|---|---|---|
| Desmodur ® H | x | x | x | x | x | x |
| Desmodur ® I | | | | | | |

Polyol

| | | | | | | |
|---|---|---|---|---|---|---|
| Polyol 4 | x | | | | | |
| Polyol 6 | | | | x | | |
| Polyol 5 | | | | | | x |
| Polyol 9 | | | | | x | |
| Polyol 10 | | x | | | | |
| Polyol 11 | | | x | | | |
| NCO/OH equivalent ratio | 15 | 10 | 25 | 10 | 15 | 15 |

Catalyst

| | | | | | | |
|---|---|---|---|---|---|---|
| Zirconium 18 | x | x | x | x | | |
| Zinc(II)-ethylhexanoate | | | | | x | x |

Stopper

| | | | | | |
|---|---|---|---|---|---|
| Dibutylphosphate | x | x | | x | |
| Isophthaloylchloride | | | x | | x |

Analytical Characteristics

| | | | | | | |
|---|---|---|---|---|---|---|
| NCO content | 14% | 13.5% | 13.5% | 9.8% | 6.1% | 6% |
| Mₙ prepolymer [g/mol] | 1040 | 1568 | 1881 | 2461 | 2719 | 3150 |
| Content Mₙ < 1000 g/mol | 37.75% | 11.5% | 15.7% | 5.05% | 6.3% | 4% |
| FGEW [g/mol] | 346.7 | 522.7 | 553.2 | 615 | 679.8 | 787.5 |
| Monomeric diisocyanate | 0.06% | 0.05% | 0.02% | 0.02% | 0.02% | 0.02% |
| content | | | | | | |
| NCO functionality prepolymer | 3 | 3 | 3.4 | 4 | 4 | 4 |
| Lysine mean depletion % | 6.26 | 2.72 | 20.54 | 0 | 0 | 0 |

Comparative Experiments H to J show a lysine mean depletion of >1, leading to the conclusion that prepolymers having a functional group equivalent weight (FGEW) of <560 g/mol will result in causing lysine mean depletion>1 in the described Direct Peptide Reactivity Assay. Inventive examples 8-10 having FGEW>560 g/mol and monomeric diisocyanate content<0.2% show lysine mean depletion<1.

TABLE 3
Correlation LLNA and DPRA results.

| | | Result DPRA | |
|---|---|---|---|
| | FGEW | Lysine mean depletion % | Result LLNA |
| Comp Ex B | 509 | 3 | positive |
| Comp Ex C | 523 | 16 | positive |
| Comp Ex E | 537.5 | 16 | positive |
| Example 4 | 870.7 | 0 | negative |
| Example 5 | 998 | 1 | negative |
| Example 6 | 1046.5 | 0 | negative |
| Example 7 | 1641.5 | 0 | negative |

Comparative Experiments B, C and E show a lysine mean depletion>1 and a positive LLNA result, leading to the conclusion that a correlation between positive results of both skin sensitization tests can be found. Inventive examples 4 to 7 show a lysine mean depletion≤1 and a negative LLNA result, showing again a positive correlation between negative results of both skin sensitization tests.

1. An isocyanate-terminated prepolymer obtained by reaction of
(I) At least one polyol, with a stoichiometric excess of
(II) At least one monomeric diisocyanate,
wherein the isocyanate-terminated prepolymer has
i. a functional group equivalent weight FGEW of ≥560 g/mol,
ii. a content of residual non-reacted monomeric diisocyanate of <0.2% by weight.

2. The isocyanate-terminated prepolymer according to claim 1, wherein the isocyanate-terminated prepolymer has a functional group equivalent weight FGEW of ≥600 g/mol, preferably ≥650 g/mol, more preferably ≥700 g/mol, even more preferably ≥800 g/mol, even more preferably ≥1000 g/mol.

3. The isocyanate-terminated prepolymer according to claim 1 or 2, wherein the isocyanate-terminated prepolymer has a functional group equivalent weight FGEW of ≤10000 g/mol, preferably ≤4000 g/mol, more preferably ≤2000 g/mol.

4. The isocyanate-terminated prepolymer according to any one of the preceding claims, wherein the at least one polyol has an average number-average molecular weight Mₙ of from 60 to 20000 g/mol, preferably from 60 to 8000 g/mol, more preferably from 60 to 4000 g/mol.

5. The isocyanate-terminated prepolymer according to any one of the preceding claims, wherein the isocyanate-terminated prepolymer contains urethane groups and/or allophanate groups and optionally functional groups selected from the group consisting of urea groups, biuret groups, uretdione groups, carbodiimide groups, uretonimine groups, isocyanurate groups and any combination thereof.

6. The isocyanate-terminated prepolymer according to any one of the preceding claims, wherein the isocyanate-terminated prepolymer is the reaction product of
(I) At least one polyol, and
(II) At least one monomeric diisocyanate,
wherein the at least one monomeric diisocyanate and the at least one polyol are used in an amount such that the NCO/OH equivalent ratio is from 1.5:1 to 25:1, preferably from 2:1 to 20:1.

7. The isocyanate-terminated prepolymer according to any one of the preceding claims, wherein the at least one monomeric diisocyanate is an aliphatic diisocyanate and/or a cycloaliphatic diisocyanate.

8. A process for preparing the isocyanate-terminated prepolymer according to any one of the preceding claims, comprising the following steps
a) mixing at least one polyol with an excess of at least one monomeric diisocyanate,
b) optionally partly or fully allophanatizing the urethane groups by further reaction with at least one monomeric diisocyanate (which may be different from those from (a)),
c) removal of the excess of the monomeric diisocyanate, if present, by distillation down to <0.2% by weight, preferably down to <0.1% by weight, based on the NCO-terminated prepolymer, to obtain the isocyanate-terminated prepolymer, and
d) optionally addition of at least one solvent inert towards isocyanate groups.

9. The process according to claim 8, comprising the following steps
a) mixing at least one polyol with an excess of at least one monomeric diisocyanate,
b) partly or fully allophanatizing the urethane groups by further reaction with at least one monomeric diisocyanate (which may be different from those from (a)),
c) removal of the excess of the monomeric diisocyanate, if present, by distillation down to <0.2% by weight, preferably down to <0.1% by weight, based on the NCO-terminated prepolymer, to obtain the isocyanate-terminated prepolymer, and
d) optionally addition of at least one solvent inert towards isocyanate groups.

10. Use of the isocyanate-terminated prepolymer according to any one of the claims 1 to 7 or obtained with the process according to claim 8 or 9 as an isocyanate-terminated prepolymer with reduced skin sensitization potential or no skin sensitization potential.

11. Use of the isocyanate-terminated prepolymer according to any one of the claims 1 to 7 or obtained with the process according to claim 8 or 9 in curable compositions for a coating system, an adhesive system, a sealant system and/or a foam system, in particular those systems which are applied manually.

12. Use according to claim 11 for reducing the skin sensitisation of a coating system, an adhesive system, a sealant system and/or a foam system, in particular for reducing the skin sensitisation of a coating system, an adhesive system, a sealant system and/or a foam system that is applied manually.

13. A coating, adhesive, sealant or foam system in particular for manual application comprising the isocyanate-terminated prepolymer according to any one of the claims 1 to 7 or obtained with the process according to claim 8 or 9.

14. A two-component system, comprising a component A), comprising at least one isocyanate-terminated prepolymer according to any one of claim 1 to 7 or obtained with the process according to claim 8 or 9, and a component B), comprising at least one compound which comprises at least one Zerewitinoff-active group.

15. A moisture-curable one-component system comprising at least one isocyanate-terminated prepolymer according to any one of claim 1 to 7 or obtained with the process according to claim 8 or 9.
